(19) United States
(12) Patent Application Publication
(10) Pub. No.: US 2016/0124603 A1
(43) Pub. Date: May 5, 2016

(54) Electronic Device Including Tactile Sensor, Operating Method Thereof, and System

(71) Applicant: Samsung Electronics Co., Ltd., Suwon-si (KR)

(72) Inventors: Jongin PARK, Seoul (KR); Changhyeon MUN, Seoul (KR); Jaehong LIM, Seoul (KR)

(21) Appl. No.: 14/928,426

(22) Filed: Oct. 30, 2015

(30) Foreign Application Priority Data
Oct. 30, 2014 (KR) 10-2014-0149308

(51) Int. Cl. G06F 3/0488; G06F 3/16; G06F 3/01; H04W 76/02

(52) U.S. Cl. CPC G06F 3/0488; H04W 76/023; G06F 3/165; G06F 3/016

(57) ABSTRACT

Embodiments of the present disclosure relate to an electronic device including a tactile sensor, an operating method thereof, and a system. The electronic device may include: at least one tactile sensor that is located on a side of the electronic device and provides a sense of touch; a display unit that displays content; and a controller that controls the at least one tactile sensor to provide a sense of touch relevant to the content.

### RELATED APPLICATION(S)

This application claims priority from and the benefit under 35 U.S.C. §119(a) of Korean Patent Application No. 10-2014-0149308, filed on Oct. 30, 2014, which is hereby incorporated by reference for all purposes as if fully set forth herein.

### BACKGROUND

Various embodiments of the present disclosure relate to an electronic device including a tactile sensor, an operating method thereof, and a system.

Recently, with the remarkable development of information and communication and semiconductor technologies, electronic devices (e.g., mobile communication terminals) have been increasingly and widely used. Accordingly, the electronic devices have become necessities for people in today's world and have provided diverse functions required by users. For example, the mobile communication terminals have provided various functions, such as a telephone call function, a function of taking an image or a video, a function of receiving a broadcast, a function of connecting to the Internet, a function of recording a voice, and the like.

Recent electronic devices provide the aforementioned various functions and include various sensors and input devices in order to enhance user convenience. For example, the electronic devices may include various types of sensors, such as a touch sensor, an acceleration sensor, a gravity sensor, a geomagnetic sensor, a temperature sensor, a humidity sensor, a motion sensor, and the like. Further, the electronic devices may include input devices, such as a plurality of physical keys, a touch key, a touch screen, and the like.

### SUMMARY

The electronic devices generally have similar input devices. For example, the electronic devices generally provide only some functional keys, such as a power key and/or a volume key, as physical keys, and are controlled through a touch screen and a plurality of sensors (a motion sensor, an infrared sensor, a fingerprint sensor, etc.). Such electronic devices have difficulty in providing various types of inputs. For example, when the electronic devices provide games that use a plurality of physical keys, the electronic devices have to provide some keys in the form of a touch key due to lack of physical keys. Accordingly, the electronic devices have a problem in that a user blocks the view of the game screen with his/her hand when operating the game using touch keys, thereby deteriorating the user's sense of immersion and convenience of the game operation.

Further, the electronic devices provide haptic feedback functions using vibration. However, the electronic devices merely provide haptic feedback by adjusting vibration intensity or vibration time, and fail to provide an actual sense of touch. For example, when an image of a cat is output, the electronic devices fail to provide a feeling of softness like that of touching the cat's fur.

Accordingly, various embodiments of the present disclosure may provide an electronic device and an operating method thereof, in which the electronic device has at least one tactile sensor on a side thereof for providing an actual sense of touch, provides various senses of touch to a user through the at least one tactile sensor, and uses the at least one tactile sensor as an input device.

In addition, various embodiments of the present disclosure may provide a system that provides various services using an electronic device that includes a tactile sensor.

An electronic device, according to an embodiment of the present disclosure, includes: at least one tactile sensor that is located on a side of the electronic device and provides a sense of touch; a display unit that displays content; and a controller that controls the at least one tactile sensor to provide a sense of touch that is relevant to the content.

A method of operating an electronic device including at least one tactile sensor, according to an embodiment of the present disclosure, includes: displaying content containing tactile information; and providing a sense of touch relating to the content through the at least one tactile sensor.

A method of operating an electronic device including at least one tactile sensor, according to an embodiment of the present disclosure, includes: establishing wired or wireless communication connection with another electronic device; receiving tactile information from the other electronic device; and providing the received tactile information through the at least one tactile sensor.

A system, according to an embodiment of the present disclosure, includes: a first electronic device that includes at least one tactile sensor on a side thereof and provides a sense of touch through the at least one tactile sensor; and a second electronic device that displays content containing tactile information and transmits tactile information corresponding to the content to the first electronic device.

According to the embodiments of the present disclosure, an actual sense of touch can be provided to a user through the at least one tactile sensor located on a side of the electronic device, and a user input can be received through the tactile sensor. In this way, a bilateral interaction using the tactile sensor can be provided in the embodiments of the present disclosure.

Furthermore, according to the embodiments of the present disclosure, various functions of the electronic device can be conveniently controlled by using the tactile sensor. In addition, various services can be provided by using the tactile sensor according to the embodiments of the present disclosure.

### BRIEF DESCRIPTION OF THE DRAWINGS

The above and other objects, features, and advantages of the present disclosure will be more apparent from the following detailed description in conjunction with the accompanying drawings, in which:

FIG. 1 is a perspective view of an electronic device according to an embodiment of the present disclosure;

FIG. 2 is a block diagram illustrating a configuration of an electronic device according to an embodiment of the present disclosure;

FIG. 3 is a flowchart illustrating a method of providing a service using a tactile sensor of an electronic device according to an embodiment of the present disclosure;

FIG. 4 illustrates various examples of providing a service using a tactile sensor of an electronic device according to an embodiment of the present disclosure;

FIG. 5 illustrate various examples of providing a service using a tactile sensor of an electronic device according to an embodiment of the present disclosure;

FIG. 6A through FIG. 6B illustrate various examples of providing a service using a tactile sensor of an electronic device according to an embodiment of the present disclosure;

FIG. 7A through FIG. 7B illustrate various examples of providing a service using a tactile sensor of an electronic device according to an embodiment of the present disclosure;

FIG. 8A through FIG. 8B illustrate various examples of providing a service using a tactile sensor of an electronic device according to an embodiment of the present disclosure;

FIG. 9 illustrates a system for providing various services using a tactile sensor according to an embodiment of the present disclosure;

FIG. 10 is a flowchart illustrating a method of providing a service using a tactile sensor of a system according to an embodiment of the present disclosure; and

FIGS. 11 through 13 illustrate various examples of providing a service using a tactile sensor of a system according to an embodiment of the present disclosure.

### DETAILED DESCRIPTION

Hereinafter, various embodiments of the present disclosure will be described with reference to the accompanying drawings. Specific embodiments are shown in the drawings and the relevant detailed descriptions are given in corresponding sections, but there is no intention to limit various embodiments of the present disclosure to the particular forms disclosed herein. For example, the present disclosure may have various embodiments while modifications and changes may be made therein. Various embodiments of the present disclosure should be construed to cover all modifications, equivalents, and/or alternatives falling within the spirit and scope of the present disclosure.

In the description of the drawings, identical or similar reference numerals are used to designate identical or similar elements.

As used in various embodiments of the present disclosure, the expressions “include”, “may include” and other conjugates refer to the existence of a corresponding disclosed function, operation, or constituent element, and do not limit one or more additional functions, operations, or constituent elements.

Further, as used in various embodiments of the present disclosure, the terms “include”, “have”, and their conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

The term “or” used in various embodiments of the present disclosure includes any or all of combinations of listed words. For example, the expression “A or B” may include A, may include B, or may include both A and B.

The expressions such as “first”, “second”, or the like used in various embodiments of the present disclosure may modify various component elements in the various embodiments but may not limit corresponding component elements. For example, the above expressions do not limit the sequence and/or importance of the elements. The above expressions are used merely for the purpose of distinguishing an element from the other elements. For example, a first user device and a second user device indicate different user devices although both of them are user devices. For example, a first element may be termed a second element, and likewise a second element may also be termed a first element without departing from the scope of various embodiments of the present disclosure.

In the case where an element is referred to as being “connected” or “accessed” to other elements, it should be understood that not only the element is directly connected or accessed to the other elements, but also another element may exist between them. Contrarily, when an element is referred to as being “directly coupled” or “directly connected” to any other element, it should be understood that no element is interposed therebetween.

The terms as used in embodiments of the present disclosure are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

For example, the electronic device may include at least one of a smartphone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MP3 player, a mobile medical appliance, a camera, and a wearable device (e.g. a Head-Mounted-Device (HMD) such as electronic glasses, electronic clothes, an electronic bracelet, an electronic necklace, an electronic appcessory, electronic tattoos, or a smartwatch).

According to some embodiments, the electronic device may be a smart home appliance. For example, the smart home appliance may include at least one of a television, a Digital Video Disc (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter).

The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may refer to a person who uses an electronic device or a device (e.g., artificial intelligence electronic device) that uses an electronic device.

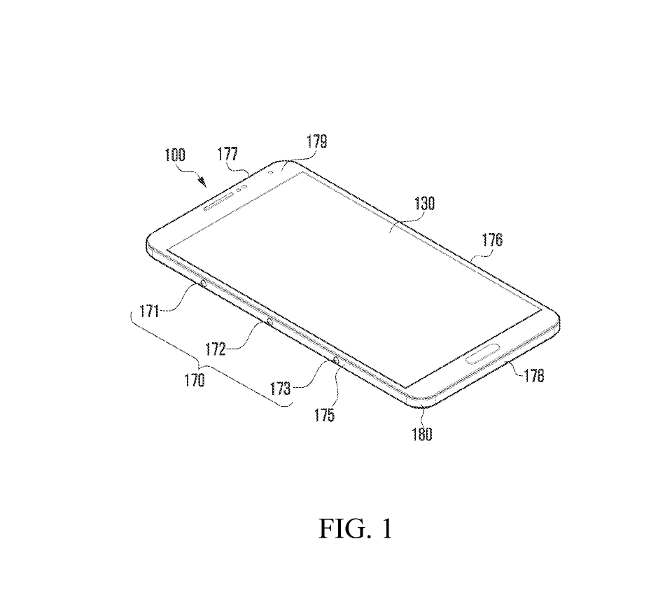

FIG. 1 is a perspective view of an electronic device according to an embodiment of the present disclosure.

Referring to FIG. 1, the electronic device 100, according to the embodiment of the present disclosure, may include a touch screen 130 on the front thereof and a tactile sensor unit 170 at a side thereof. The tactile sensor unit 170 may include one or more tactile sensors. For example, as illustrated in FIG. 1, the tactile sensor unit 170 may include three tactile sensors—a first tactile sensor 171, a second tactile sensor 172, and a third tactile sensor 173. Meanwhile, although the electronic device 100 includes one tactile sensor unit 170 on a left side 175 in FIG. 1, the electronic device 100, according to the embodiment of the present disclosure, may include one or more tactile sensor units at various locations thereon. For example, the electronic device 100, according to the embodiment of the present disclosure, may include a tactile sensor unit on at least one of the left side 175, a right side 176, a upper side 177, a lower side 178, a top side (upper surface), and a bottom side (lower surface) 180.

The first tactile sensor 171, the second tactile sensor 172, and the third tactile sensor 173 may provide sensations of touches of an object. For example, when the electronic device 100 displays an image of wool, at least one of the first tactile sensor 171, the second tactile sensor 172, and the third tactile sensor 173 may provide a soft feeling of the wool. Alternatively, when the electronic device 100 displays an image of a stone, at least one of the first tactile sensor 171, the second tactile sensor 172, and the third tactile sensor 173 may provide a hard touch of a stone. In another case, at least one of the first tactile sensor 171, the second tactile sensor 172, and the third tactile sensor 173 may provide a different sense of touch. For example, the first tactile sensor 171 may provide a feeling of softness, the second tactile sensor 172 may provide a feeling of hardness, and the third tactile sensor 173 may provide a feeling of coolness. In another case, the first tactile sensor 171 and the second tactile sensor 172 may provide a feeling of softness, and the third tactile sensor 173 may provide a feeling of coolness.

The first tactile sensor 171, the second tactile sensor 172, and the third tactile sensor 173 may also have input functions. For example, when a user presses the first tactile sensor 171 with a predetermined magnitude of force, the electronic device 100 may recognize that a user input is entered into the first tactile sensor 171. Further, the user input may include a touch and a touch movement (e.g., a drag, a sweep, etc.).

As described above, the first tactile sensor 171, the second tactile sensor 172, and the third tactile sensor 173 may be bilateral sensors that provide both an output function and an input function. That is, the electronic device 100, according to the embodiment of the present disclosure, may provide a bilateral interaction using the tactile sensors. In the embodiment of the present disclosure, the electronic device 100 may control various functions thereof using the first tactile sensor 171, the second tactile sensor 172, and the third tactile sensor 173. For example, the electronic device 100, according to the embodiment of the present disclosure, may control functions, such as a game, music/video playback, unlocking, volume control, page turning, zoom in/out, etc., using the first tactile sensor 171, the second tactile sensor 172, and the third tactile sensor 173.

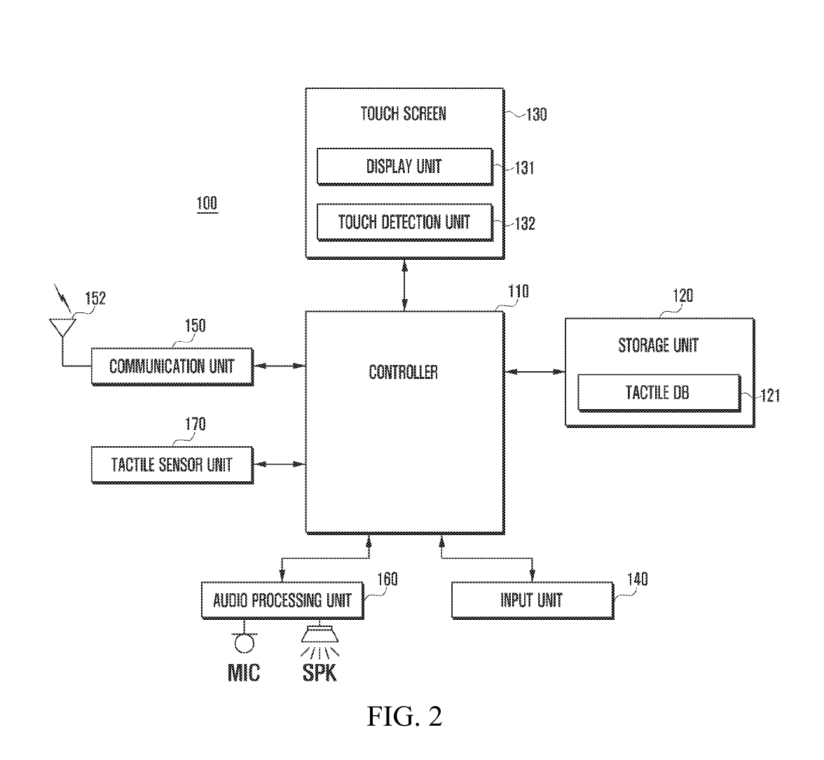

FIG. 2 is a block diagram illustrating a configuration of an electronic device according to an embodiment of the present disclosure.

Referring to FIG. 2, the electronic device 100, according to the embodiment of the present disclosure, may include a controller 110, a storage unit 120, a touch screen 130, an input unit 140, a communication unit 150, an audio processing unit 160, and a tactile sensor unit 170. The touch screen 130 may include a display unit 131 and a touch detection unit 132.

The controller 110 may control an overall operation thereof and a signal flow between internal blocks thereof, and may perform a data processing function of processing data. For example, the controller 110 may be configured with a central processing unit (CPU), an application processor (AP), etc. The controller 110 may be configured with a single core processor or a multi-core processor. Furthermore, the controller 110 may be configured with a plurality of processors.

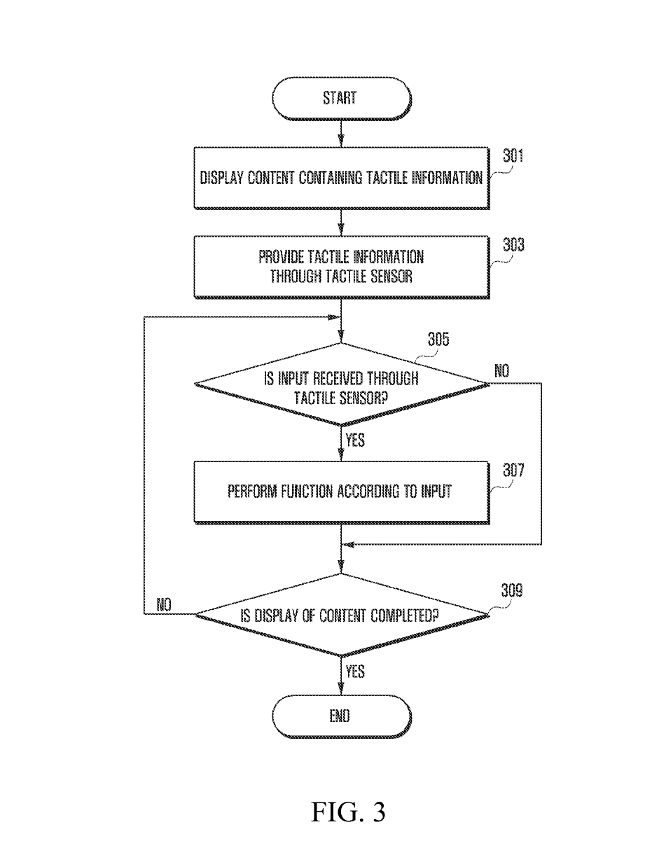

The controller 110, according to the embodiment of the present disclosure, may display content or tactile sensation providing content containing tactile information. The tactile sensation providing content may be an image, a video, a game, etc. The controller 110 may control at least one tactile sensor (e.g., some or all of the first tactile sensor 171, the second tactile sensor 172, and the third tactile sensor 173 of FIG. 1) included in the tactile sensor unit 170 to provide tactile information on the displayed tactile sensation providing content. The controller 110 may receive an input through the tactile sensor and may process the received input. A detailed description thereof will be given below with reference to FIGS. 3 through 8.

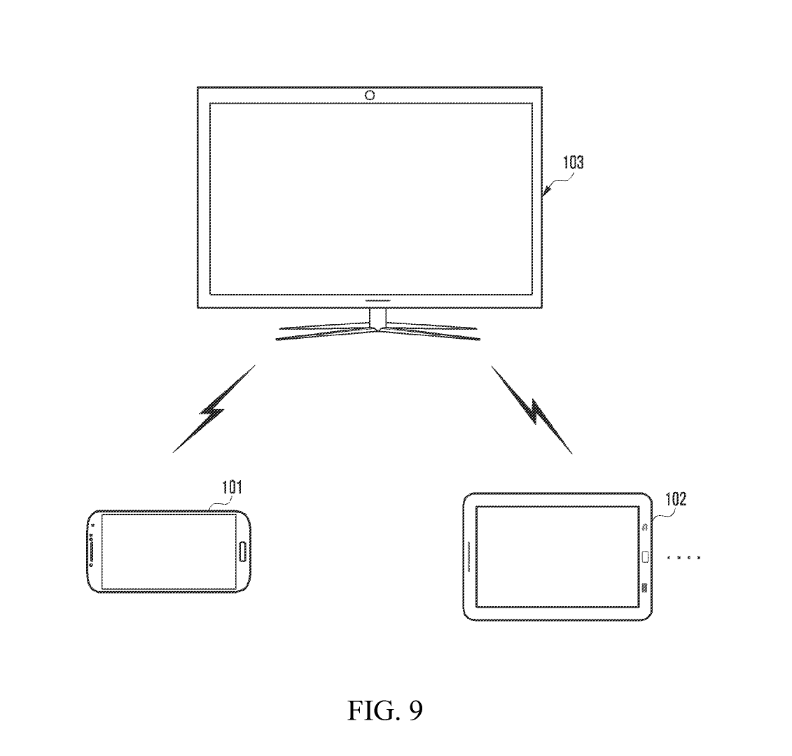

The controller 110 may receive tactile information through the communication unit 150 from another electronic device, and may provide the received tactile information through a tactile sensor (e.g., the first tactile sensor 171, the second tactile sensor 172, or the third tactile sensor 173 of FIG. 1) of the tactile sensor unit 170. The controller 110 may transmit an input received through the tactile sensor to the other electronic device, and may receive a result according to the input. A detailed description thereof will be given below with reference to FIGS. 9 through 13.

The storage unit 120 may store an operating system (OS) of the electronic device 100 and application programs necessary for other optional functions, such as an audio reproduction function, an image or video reproduction function, a broadcast reproduction function, an Internet access function, a text message function, a game function, a navigation service function, and the like. Further, the storage unit 120 may store various types of data, such as music data, video data, game data, audio data, movie data, map data, etc.

The storage unit 120 may include or pre-store a tactile database (DB), or a tactile DB 121. In the tactile DB 121, a target may be mapped with tactile information or data representing the sense of touch thereof. For example, in the tactile DB 121, stone may be mapped with the hard touch thereof, and woolen clothes may be mapped with the soft touch thereof. Alternatively, the tactile DB 121 may store tactile information or data for representing functions, such as volume up, volume down, backward page turning, forward page turning, etc. For example, in the tactile DB 121, volume up or volume down may be mapped with the sense of touch similar to turning a conventional rotary volume button. In this case, the sense of touch mapped with the target or function may be changed by a user.

The tactile DB 121 may be stored when the electronic device 100 is manufactured, or may be downloaded and stored by a user selection. Further, the tactile DB 121 may be updated periodically or by a user. Meanwhile, the tactile DB 121 may be provided together with content (an image, a video, a game, etc.).

The touch screen 130 may perform an input function and a display function. To this end, the touch screen 130 may include the display unit 131 and the touch detection unit 132.

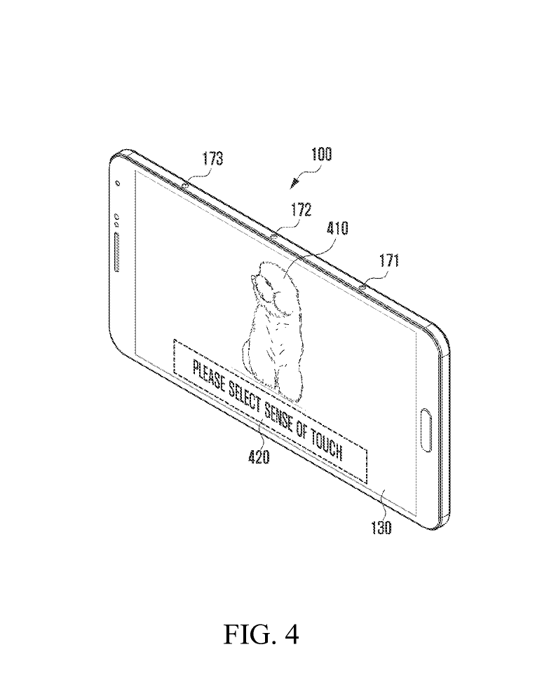

The display unit 131 displays information input by a user or information to be provided to the user as well as various menus of the electronic device 100. The display unit 131 may be formed of a liquid crystal display (LCD), an organic light emitted diode (OLED), an active matrix organic light emitted diode (AMOLED), or the like. The display unit 131 may provide various screens according to the use of the electronic device 100, for example, a home screen, a menu screen, a locked screen, a game screen, a webpage screen, a call screen, and the like. The display unit 131, according to the embodiment of the present disclosure, may display various screens (e.g., FIGS. 4 through 8 and FIGS. 11 through 13) that can provide tactile information.

As a device for providing an input function, the touch detection unit 132 may generate a touch event and transfer the generated touch event to the controller 110 when a touch input unit, such as a user's finger, a stylus pen, or a touch pen, contacts or approaches the touch detection unit. Specifically, the touch detection unit 132 may recognize an occurrence of a touch event based on a change in a physical quantity (e.g., capacitance, resistance, etc.) according to a contact or approach by the touch input unit. Further, the touch detection unit 132 may further include an electromagnetic induction type of touch panel for recognizing an electromagnetic induction type of electronic pen. Since the touch detection unit 132 is apparent to those skilled in the art to which the present disclosure pertains, a detailed description thereof will be omitted.

The input unit 140 may generate an input signal of the electronic device 100. The input unit 140 may include a hardware physical key, such as at least one home key, a side key, etc. The input unit 140 may include a touch type of input device, such as a touch pad, a touch panel, a touch sheet, etc. Herein, the touch type of input device may include an electronic pen or a typical pen, as well as a hand.

The communication unit 150 may support a wired and/or wireless communication function of the electronic device 100. For example, the communication unit 150 may include a mobile communication module for supporting a mobile communication (e.g., mobile communication of the 2^{nd} generation (2G), 3^{rd} generation (3G), 4^{th} generation (4G), and/or 5^{th} generation (5G) standard) function, a wireless LAN communication module for supporting a short-range wireless communication function, a Bluetooth communication module, an infrared communication module, a Zigbee communication module, a universal serial bus (USB) communication module for supporting a wired communication function, an HDMI communication module, etc.

The communication unit 150, according to the embodiment of the present disclosure, may receive content (an image, a video, a game, etc.) containing tactile information. Alternatively, the communication unit 150 may receive the tactile DB 121 from an external device (e.g., a server) under the control of the controller 110.

The communication unit 150 may transmit a message for requesting tactile information relating to currently displayed content to a preset server (a tactile sensation providing server) to receive the tactile information under the control of the controller 110. For example, when an image of a cat is displayed on the display unit 131, the communication unit 150 may request information on the feeling of touching a cat from the preset server to receive the information under the control of the controller 110.

The communication unit 150, according to the embodiment of the present disclosure, may connect a wired or wireless communication channel with a second electronic device (e.g., a television (TV), a tablet personal computer (PC), a monitor, a set-top box, a console game device, etc.) under the control of the controller 110. The communication unit 150 may receive, from the second electronic device, tactile information relating to the content that is being displayed on the second electronic device connected thereto through communication. Further, the communication unit 150 may transmit a user input detected through the tactile sensor unit 170 to the second electronic device under the control of the controller 110, for example, via an antenna 152. The communication unit 150 may receive feedback on the user input from the second electronic device.

The audio processing unit 160 may be connected to a speaker SPK and at least one microphone MIC. The speaker SPK outputs an audio signal transmitted/received during a call, an audio signal included in a received message, or an audio signal according to the reproduction of an audio file stored in the storage unit 120, and the microphone MIC collects a user's voice or other audio signals. For example, the audio processing unit 160 may output an audio signal according to the reproduction of a music file, the reproduction of a video file, the execution of a game, etc. through the speaker SPK.

In some embodiments, the tactile sensor unit 170 may include one or more of the first tactile sensor 171, the second tactile sensor 172, and the third tactile sensor 173 of FIG. 1. One or more of the first tactile sensor 171, the second tactile sensor 172, and the third tactile sensor 173 included in the tactile sensor unit 170 may have an output function and an input function. For example, the tactile sensor unit 170 may provide a sense of touch to a user, and may receive a user input (e.g., a touch and a touch movement).

Although not illustrated in FIG. 2, the electronic device 100 may selectively further include a broadcast reception module for receiving a broadcast, a digital sound source playback module, such as an MP3 module, and various sensor modules, such as an infrared sensor module, an illumination sensor module, a motion sensor module, etc. Further, the electronic device 100, according to the embodiment of the present disclosure, may further include elements at the same level as the aforementioned elements.

FIG. 3 is a flowchart illustrating a method of providing a service using a tactile sensor of an electronic device according to an embodiment of the present disclosure.

Referring to FIG. 3, the controller 110 (of FIG. 2) of the electronic device 100, according to the embodiment of the present disclosure, may display content containing tactile information (hereinafter, referred to as tactile sensation providing content) in operation 301. The tactile sensation providing content may be an image, a video, a game, etc.

In operation 303, the controller 110 of FIG. 2 may extract tactile information from the tactile sensation providing content and provide the extracted tactile information through at least one tactile sensor (e.g., one or more of the first tactile sensor 171, the second tactile sensor 172, and the third tactile sensor 173 of FIG. 1).

In operation 305, the controller 110 of FIG. 2 may identify whether an input is received through the at least one tactile sensor (e.g., one or more of the first tactile sensor 171, the second tactile sensor 172, and the third tactile sensor 173 of FIG. 1).

When an input is not received, the controller 110 may proceed to operation 309, which will be described below. In contrast, when an input is received, the controller 110 may proceed to operation 307 to perform a function corresponding to the received input. For example, the controller 110, while executing a car game, may control to turn a car according to an input through one or more of the first tactile sensor 171, the second tactile sensor 172, and the third tactile sensor 173 of FIG. 1. Alternatively, when music is played back, the controller 110 may turn the volume up or down according to an input through one or more of the first tactile sensor 171, the second tactile sensor 172, and the third tactile sensor 173 of FIG. 1. A detailed description of various service providing methods using a tactile sensor will be given below.

In operation 309, the controller 110 may identify whether the display of the tactile sensation providing content is completed. When the display of the tactile sensation providing content is completed, the controller 110 may complete the service using one or more of the first tactile sensor 171, the second tactile sensor 172, and the third tactile sensor 173 of FIG. 1. In contrast, when the display of the tactile sensation providing content is not completed, the controller 110 may return to operation 305 to repeat the aforementioned operations.

Meanwhile, in FIG. 3, it has been exemplified that the tactile information is included in the content. However, the tactile information may be extracted from the tactile DB 121, or may be received from an external device (e.g., a tactile information providing server). Specifically, the controller 110 may recognize an object included in the currently displayed image through an object recognition technology, and may extract tactile information for the recognized object from the tactile DB 121 stored in the storage unit 120, or may request the tactile information from an external device (e.g., the tactile information providing server) to receive the same.

FIGS. 4 through 8 illustrate various examples of providing a service using a tactile sensor of an electronic device according to an embodiment of the present disclosure.

First, referring to FIG. 4, the electronic device 100, according to the embodiment of the present disclosure, may provide a game using a tactile sensor. For example, as illustrated in FIG. 4, the electronic device 100 may display an image 410 of a dog on the touch screen 130 and may output a message 420 for selecting the sense of touch corresponding to the displayed image 410 of the dog. In this case, the electronic device 100 provides the sense of touch corresponding to the image 410 of the dog through one of the first tactile sensor 171, the second tactile sensor 172, and the third tactile sensor 173, and provides a different sense of touch irrelevant to the image 410 of the dog through the other of the first tactile sensor 171, the second tactile sensor 172, and the third tactile sensor 173. A user may touch the first tactile sensor 171, the second tactile sensor 172, and the third tactile sensor 173, and then select (press) a tactile sensor (e.g., the first tactile sensor 171, the second tactile sensor 172, and the third tactile sensor 173) that is determined to provide the sense of touch corresponding to the image 410 of the dog. When a selection of a specific tactile sensor is detected, the electronic device 100 may determine whether the selected tactile sensor is the correct one, and may notify the user of the result through at least one of visual, auditory, and tactile means.

As described above, the electronic device 100, according to the embodiment of the present disclosure, may provide the game using the tactile sensors.

According to some embodiments, the electronic device 100 of the present disclosure may be utilized as an educational device that informs infants of the sense of touch of an object. For example, the electronic device 100 may allow infants to recognize the sense of touch of an object by displaying the object and providing the sense of touch of the currently displayed object through a tactile sensor. Similarly, the embodiment of the present disclosure may also be used in an electronic book service. For example, when a user reads an electronic book, the electronic device 100, according to the embodiment of the present disclosure, may provide the feeling of an image that is being displayed on the current page, to the user through a tactile sensor.

In addition, the electronic device 100, according to the embodiment of the present disclosure, may be utilized as an educational device for blind people. For example, the electronic device 100 may inform a user of an object through an audio signal and may provide the feeling of the object through a tactile sensor.

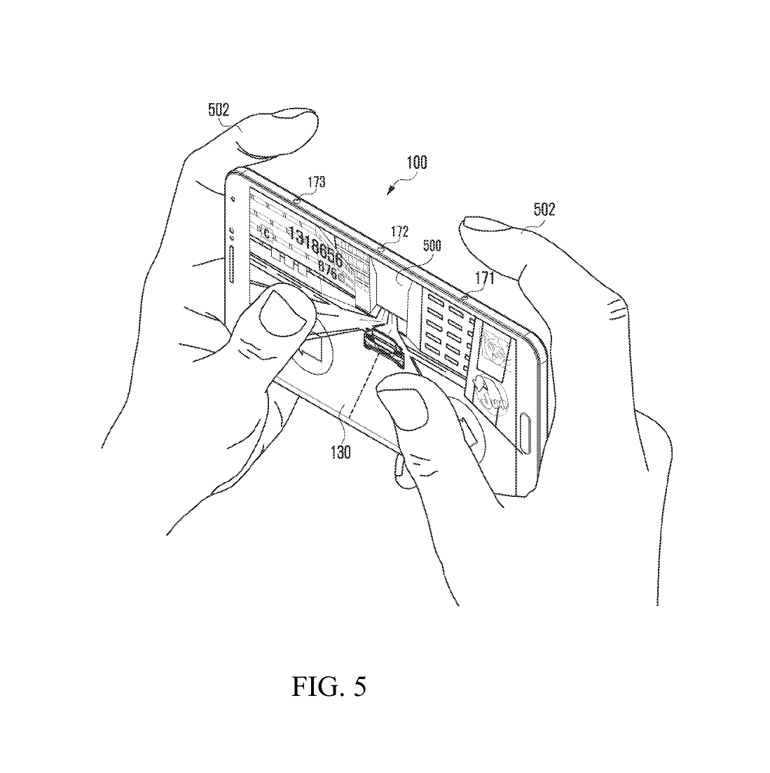

Referring to FIG. 5, the electronic device 100, according to the embodiment of the present disclosure, may control a game operation using a tactile sensor. For example, the electronic device 100 may control a car racing game. Specifically, the electronic device 100 may turn a car rightward on a car racing game screen 500 when the first tactile sensor 171 detects an input from a user 502, and may turn the car leftward on the car racing screen when the third tactile sensor 173 detects an input.

In addition, when controlling the car racing game using the first tactile sensor 171 and the third tactile sensor 173, the electronic device 100 may provide the sense of touch corresponding to a game context (a road, a gravelly field, a thicket, etc.) to a user through the first tactile sensor 171, the second tactile sensor 172, and the third tactile sensor 173. For example, in the case of a road, the electronic device 100 may provide, through the first tactile sensor 171 and the third tactile sensor 173, a feeling as if a steering wheel is slightly shaken, and in the case of a gravelly field, the electronic device 100 may provide, through the first tactile sensor 171 and the third tactile sensor 173, a feeling as if the steering wheel is seriously shaken.

According to some embodiments, the first tactile sensor 171 may function as an accelerator pedal, and the third tactile sensor 173 may function as a brake pedal. In this case, the car may be controlled to turn through a motion of the electronic device 100 (e.g., left or right tilting) or through an input on the touch screen 130 (e.g., left or right touch, leftward or rightward scrolling, etc.) as before.

According to some embodiments, the electronic device 100 may control the car to turn by a combination of a motion sensor and one of the first tactile sensor 171, the second tactile sensor 172, and the third tactile sensor 173. For example, the car may be rapidly turned rightward if the first tactile sensor 171 detects an input (e.g., a touch or a touch movement) while the car is turned rightward by inclining the electronic device 100 rightward (or at the same time that the electronic device is inclined rightward).

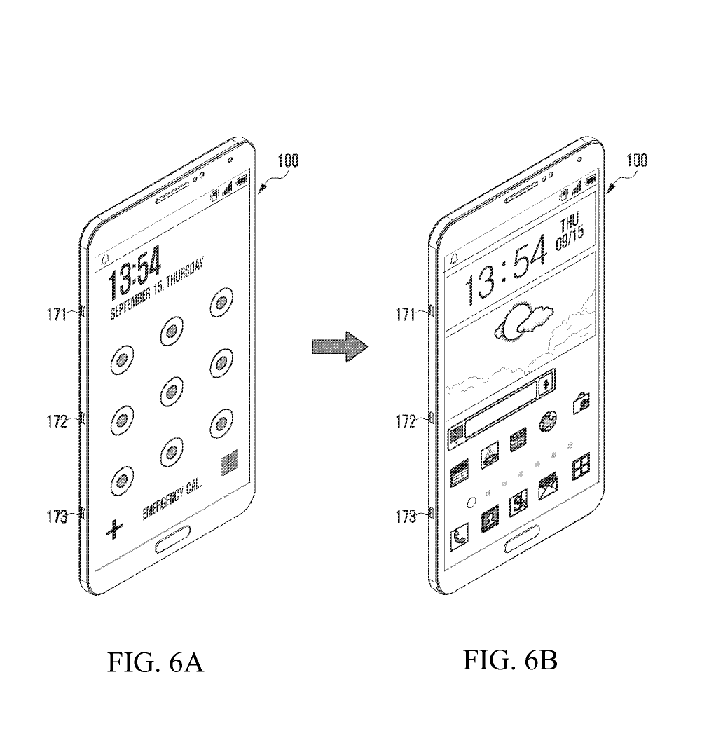

Referring to FIGS. 6A and 6B, the electronic device 100, according to the embodiment of the present disclosure, may perform an unlocking operation using a tactile sensor. For example, the electronic device 100 may control the first tactile sensor 171, the second tactile sensor 172, and the third tactile sensor 173 to provide different senses of touch when a lock screen image is output as illustrated in FIG. 6A. For example, the first tactile sensor 171 may provide a feeling of warmth, the second tactile sensor 172 may provide a feeling of roughness, and the third tactile sensor 173 may provide a feeling of coolness. The electronic device 100 may detect inputs received from the first tactile sensor 171, the second tactile sensor 172, and the third tactile sensor 173. In cases where the detected inputs agree with preset unlocking tactile information, the electronic device 100 may release the locking as illustrated in FIG. 6B. For example, the unlocking tactile information for unlocking the electronic device 100 may be set to coolness, coolness, and warmth, and the electronic device 100 may release the locking when detecting an input of the third tactile sensor 173, an input of the third tactile sensor 173, and an input of the first tactile sensor 171 in a serial order.

According to some embodiments, when a lock screen image is output, the electronic device 100 may arbitrarily change the senses of touch that the first tactile sensor 171, the second tactile sensor 172, and the third tactile sensor 173 provide. In this case, despite the same unlocking tactile information, the sequence in which the first tactile sensor 171, the second tactile sensor 172, and the third tactile sensor 173 are pressed may be changed every time the locking is released. As such, the embodiment of the present disclosure may prevent other people from recognizing the unlocking tactile information even if the sequence in which a user presses the first tactile sensor 171, the second tactile sensor 172, and the third tactile sensor 173 is exposed to the outside.

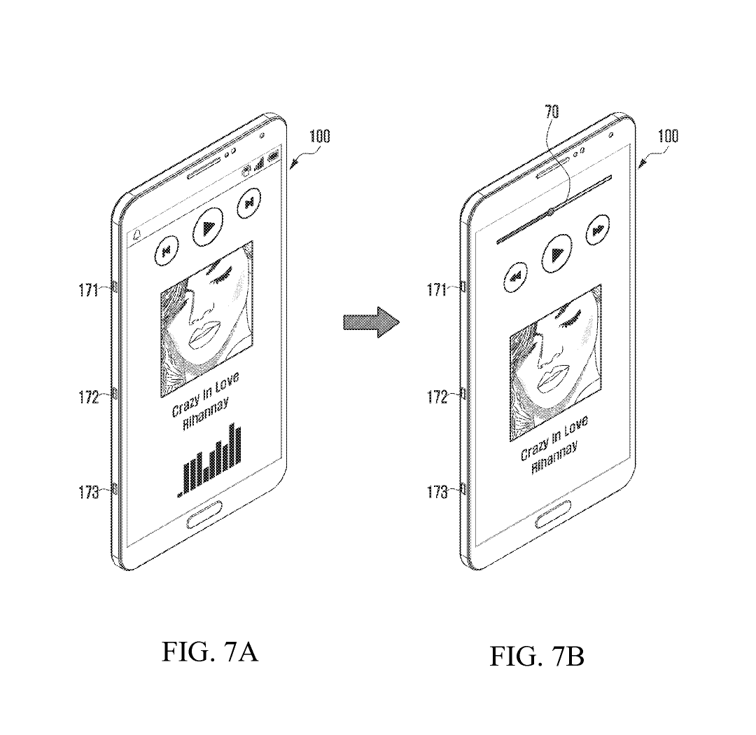

Referring to FIGS. 7A and 7B, the electronic device 100, according to the embodiment of the present disclosure, may control volume using a tactile sensor. For example, when an input of the first tactile sensor 171 or the second tactile sensor 172 is detected while a music playback application is executed as illustrated in FIG. 7A, the electronic device 100 may turn the volume up or down and may output a volume bar 70 as illustrated in FIG. 7B. Specifically, the electronic device 100 may turn the volume up when an input (touch) of the first tactile sensor 171 is detected, and may turn the volume down when an input (touch) of the second tactile sensor 172 is detected. In this case, the electronic device 100 may control the first tactile sensor 171 and the second tactile sensor 172 to provide different senses of touch. This may help a user to recognize the volume up/down through the sense of touch.

According to some embodiments, the electronic device 100 may turn the volume up when one of the first tactile sensor 171, the second tactile sensor 172, and the third tactile sensor 173 detects a touch movement in an upward direction (or in a right direction in a portrait mode (FIG. 5)), and may turn the volume down when one of the first tactile sensor 171, the second tactile sensor 172, and the third tactile sensor 173 detects a touch movement in a downward direction (or in a left direction in a portrait mode (FIG. 5)). In this case, the electronic device 100 may provide a feeling that is similar to turning a conventional rotary volume device through the tactile sensor which detects the input.

Meanwhile, the volume control through the tactile sensors may be used in a telephone call, video playback, etc. as well as music playback.

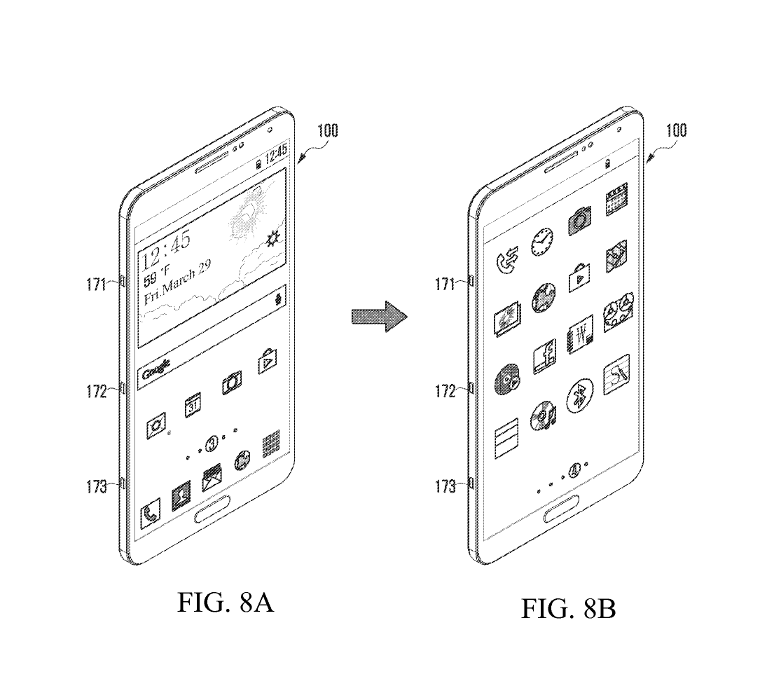

Referring to FIGS. 8A and 8B, the electronic device 100, according to the embodiment of the present disclosure, may control page turning using a tactile sensor. For example, when an input (touch) of the first tactile sensor 171 is detected while the third page of a home screen configured with a plurality of pages is output as illustrated in FIG. 8A, the electronic device 100 may move or advance to the next page, namely, to the fourth page as illustrated in FIG. 8B. In contrast, in cases where an input of the third tactile sensor 173 is detected, the electronic device 100 may move or return to the previous page.

Alternatively, the electronic device 100 may move to the next page when one of the first tactile sensor 171, the second tactile sensor 172, and the third tactile sensor 173 detects a touch movement in an up direction (or in a right direction in a portrait mode (FIG. 5)), and may move or return to the previous page when one of the first tactile sensor 171, the second tactile sensor 172, and the third tactile sensor 173 detects a touch movement in a down direction (or in a left direction in a portrait mode (FIG. 5)). In this case, the tactile sensor that detects the user input may provide a predefined sense of touch in order to represent the movement to the previous and/or next page. The predefined sense of touch may be changed by the user.

Meanwhile, page turning through the tactile sensors may also be utilized in a web page, an electronic book, a text message, a gallery, etc.

According to some embodiments, page turning through the tactile sensors may also be applied to a movement (scroll) of the currently displayed screen.

FIG. 9 illustrates a system for providing various services using a tactile sensor according to an embodiment of the present disclosure.

Referring to FIG. 9, the system 1000, according to the embodiment of the present disclosure, may include a first electronic device 101, a second electronic device 102, and a third electronic device 103.

The first electronic device 101 and the second electronic device 102 may have small displays, and the third electronic device 103 may have a large display. For example, the first electronic device 101 and the second electronic device 102 may be a smart phone, a tablet PC, etc., and the third electronic device 103 may be a TV, a monitor, etc.

The first electronic device 101, the second electronic device 102, and the third electronic device 103 may establish a short-range wireless communication network. For example, the first electronic device 101, the second electronic device 102, and the third electronic device 103, may establish a short-range wireless communication network through Bluetooth, Wi-Fi Direct, a wireless local area network (LAN), etc. In this case, the third electronic device 103 may act as a master that controls an overall operation of the system, and the first electronic device 101 and the second electronic device 102 may act as a slave.

Although the first electronic device 101, the second electronic device 102, and the third electronic device 103 are directly connected to each other in FIG. 9, the first electronic device 101, the second electronic device 102, and the third electronic device 103 may also be connected through an access point (AP) (not shown), a set-top box (not shown), a console game device (not shown), etc. Further, although the first electronic device 101, the second electronic device 102, and the third electronic device 103 are connected to each other in a wireless manner in FIG. 9, the first electronic device 101, the second electronic device 102, and the third electronic devices 103 may also be connected in a wired manner. In addition, although the first electronic device 101, the second electronic device 102, and the third electronic device 103 establish the wireless communication network in FIG. 9, two or more of the first electronic device 101, the second electronic device 102, and the third electronic device 103 may establish a short-range wireless communication network in the embodiment of the present disclosure.

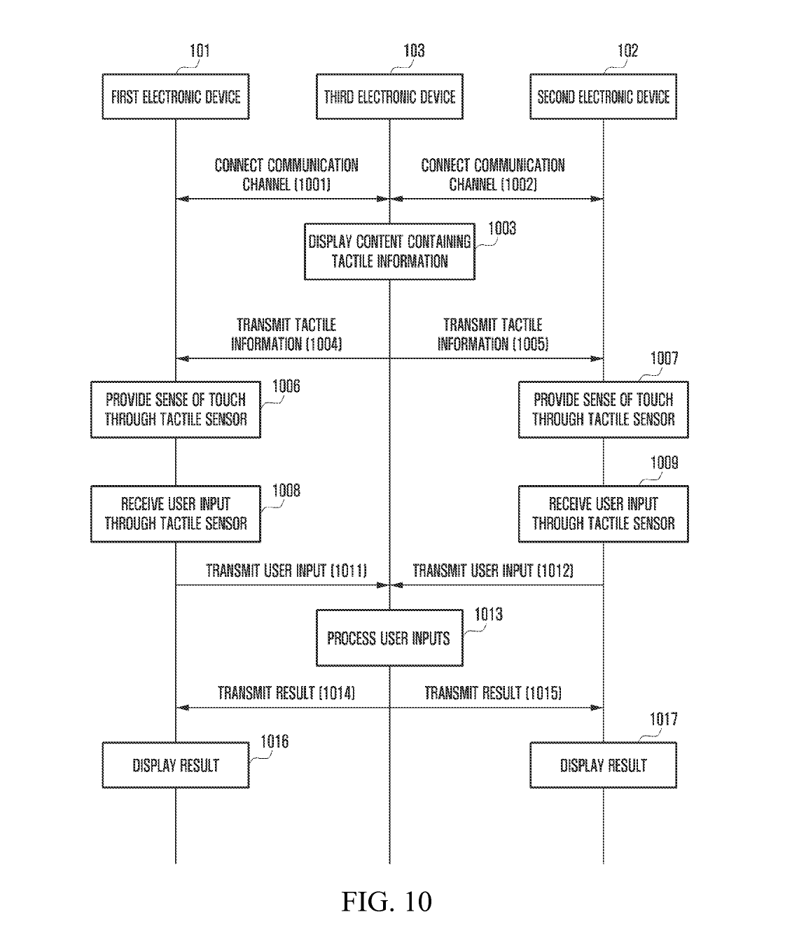

A system 1000, according to the embodiment of the present disclosure, may provide diverse services (e.g., games) using a tactile sensor (e.g., the first tactile sensor 171, the second tactile sensor 172, and the third tactile sensor 173 of FIG. 1). A detailed description thereof will be given below with reference to FIGS. 10 through 13.

FIG. 10 is a flowchart illustrating a method of providing a service using a tactile sensor of a system according to an embodiment of the present disclosure.

Referring to FIG. 10, the third electronic device 103 of the system 1000, according to the embodiment of the present disclosure, may connect communication channels with the first electronic device 101 and the second electronic device 102 in operations 1001 and 1002. The communication channels may be wired or wireless communication channels.

In operation 1003, the third electronic device 103 may display content (tactile sensation providing content) containing tactile information. The tactile sensation providing content may be an image, a video, a game, etc.

In operations 1004 and 1005, the third electronic device 103 may transmit the tactile information to the first electronic device 101 and the second electronic device 102.

The first electronic device 101 in response to having received the tactile information may provide a sense of touch through at least one tactile sensor in operation 1006. Further, the second electronic device 102 in response to having received the tactile information may provide a sense of touch through at least one tactile sensor in operation 1007.

In operation 1008, the first electronic device 101 may receive a user input through at least one tactile sensor. Further, in operation 1009, the second electronic device 102 may receive a user input through at least one tactile sensor.

In operations 1011 and 1012, the first electronic device 101 and the second electronic device 102 may transmit the received user inputs to the third electronic device 103.

In operation 1013, the third electronic device 103 having received the user inputs from the first electronic device 101 and the second electronic device 102 may process the received user inputs.

In operations 1014 and 1015, the third electronic device 103 may transmit the processing results to the first electronic device 101 and the second electronic device 102.

In operations 1016 and 1017, the first electronic device 101 and the second electronic device 102 having received the processing results may display the results.

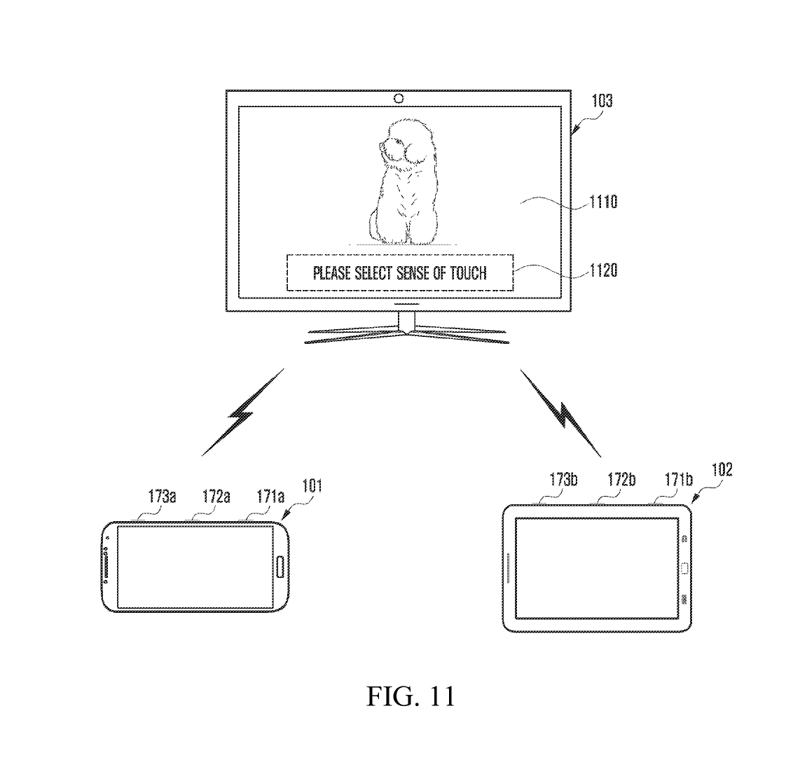

FIGS. 11 through 13 illustrate various examples of providing a service using a tactile sensor of a system according to an embodiment of the present disclosure.

First, referring to FIG. 11, the system 1000 of FIG. 10, according to the embodiment of the present disclosure, may provide a game service of guessing a sense of touch. For example, the third electronic device 103 may output a dog image 1110 containing tactile information and a popup window 1120, “Please select sense of touch.” The third electronic device 103 transmits, to the first electronic device 101 and the second electronic device 102, tactile information corresponding to the dog image 1110 and one or more pieces of different tactile information that are not related to the dog image 1110. For example, if it is assumed that each of the first electronic device 101 and the second electronic device 102 includes three tactile sensors, the third electronic device 103 may transmit tactile information to the first electronic device 101 and the second electronic device 102 such that first tactile sensors 171a and 171b provide feelings of hardness, second tactile sensors 172a and 172b provide feelings of softness, and third tactile sensors 173a and 173b provide feelings of roughness.

The first electronic device 101 and the second electronic device 102 having received the tactile information may provide the received tactile information through the plurality of tactile sensors. For example, the first electronic device 101 and the second electronic device 102 may provide the feelings of hardness through the first tactile sensors 171a and 171b, the feelings of softness through the second tactile sensors 172a and 172b, and the feelings of roughness through the third tactile sensors 173a and 173b.

Users of the first electronic device 101 and the second electronic device 102 may touch the first tactile sensors 171a and 171b, the second tactile sensors 172a and 172b, and the third tactile sensor 173a and 173b, and select the tactile sensors that provide the sense of touch corresponding to the dog image 1110 which is being output on the third electronic device 103.

The first electronic device 101 and the second electronic device 102 may transmit information on the tactile sensors selected by the users to the third electronic device 103. The third electronic device 103 may determine a presence or absence of a correct answer based on the tactile sensor information received from the first electronic device 101 and the second electronic device 102, and may feed the determination result back to the first electronic device 101 and the second electronic device 102. For example, in cases where the user of the first electronic device 101 selects the first tactile sensor 171a, and the user of the second electronic device 102 selects the second tactile sensor 172b, the third electronic device 103 may provide feedback for notifying of an incorrect answer to the first electronic device 101 and may provide feedback for notifying of a correct answer to the second electronic device 102.

According to some embodiments, the third electronic device 103 may also provide feedback for informing of defeat to the first electronic device 101, having entered the incorrect answer, and feedback for informing of victory to the second electronic device 102 having entered the correct answer. If both the first electronic device 101 and the second electronic device 102 enter correct answers, the third electronic device 103 may compare the time when the tactile sensor information is received from the first electronic device 101 and the second electronic device 102, and may determine that the user of the electronic device that transmits the tactile sensor information first wins the game.

Although the first electronic device 101 and the second electronic device 102 display the game result in the above description, the third electronic device 103 may also display the game result. Alternatively, the third electronic device 103 may display the entire result, and may transmit only the corresponding result to each of the first electronic device 101 and the second electronic device 102.

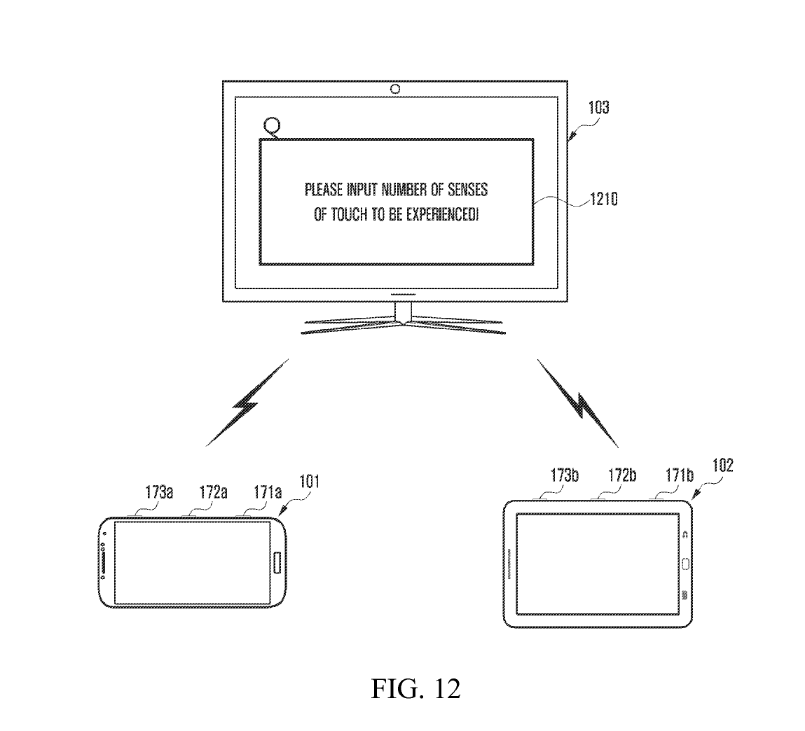

Next, referring to FIG. 12, the system 1000, according to the embodiment of the present disclosure, may provide a game service of guessing the number of senses of touch. For example, the third electronic device 103 may output a popup window 1210, “Please input number of senses of touch to be experienced!” The third electronic device 103 transmits tactile information to the first electronic device 101 and the second electronic device 102. For example, if it is assumed that each of the first electronic device 101 and the second electronic device 102 includes a plurality of tactile sensors, the third electronic device 103 may transmit tactile information to the first electronic device 101 and the second electronic device 102 such that the first tactile sensors 171a and 171b provide feelings of roughness, the second tactile sensors 172a and 172b provide feelings of softness, and the third tactile sensors 173a and 173b do not provide a sense of touch.

The first electronic device 101 and the second electronic device 102 in response to having received the tactile information may provide the received tactile information through the plurality of tactile sensors. For example, the first electronic device 101 and the second electronic device 102 may provide the feelings of roughness through the first tactile sensors 171a and 171b and the feelings of softness through the second tactile sensors 172a and 172b, and may not provide a sense of touch through the third tactile sensors 173a and 173b.

Users of the first electronic device 101 and the second electronic device 102 may touch the first tactile sensors 171a and 171b, the second tactile sensors 172a and 172b, and the third tactile sensor 173a and 173b and then select the tactile sensors that provide a sense of touch.

The first electronic device 101 and the second electronic device 102 may transmit information on the tactile sensors selected by the users to the third electronic device 103. The third electronic device 103 may determine the presence or absence of a correct answer based on the tactile sensor information received from the first electronic device 101 and the second electronic device 102, and may feed the determination result back to the first electronic device 101 and the second electronic device 102. For example, in cases where the user of the first electronic device 101 selects the first tactile sensor 171a, and the user of the second electronic device 102 selects the first tactile sensor 171b, the second tactile sensor 172b, and the third tactile sensor 173b, the third electronic device 103 may provide feedback for representing a correct answer to the first electronic device 101 and feedback for representing an incorrect answer to the second electronic device 102.

According to some embodiments, the third electronic device 103 may also provide feedback for informing of victory to the first electronic device 101, having entered the correct answer, and feedback for informing of defeat to the second electronic device 102 having entered the incorrect answer. If both the first electronic device 101 and the second electronic device 102 enter correct answers, the third electronic device 103 may compare the time when the last tactile sensor information is received from the first electronic device 101 and the second electronic device 102, and may determine that the user of the electronic device that transmits the tactile sensor information first wins the game.

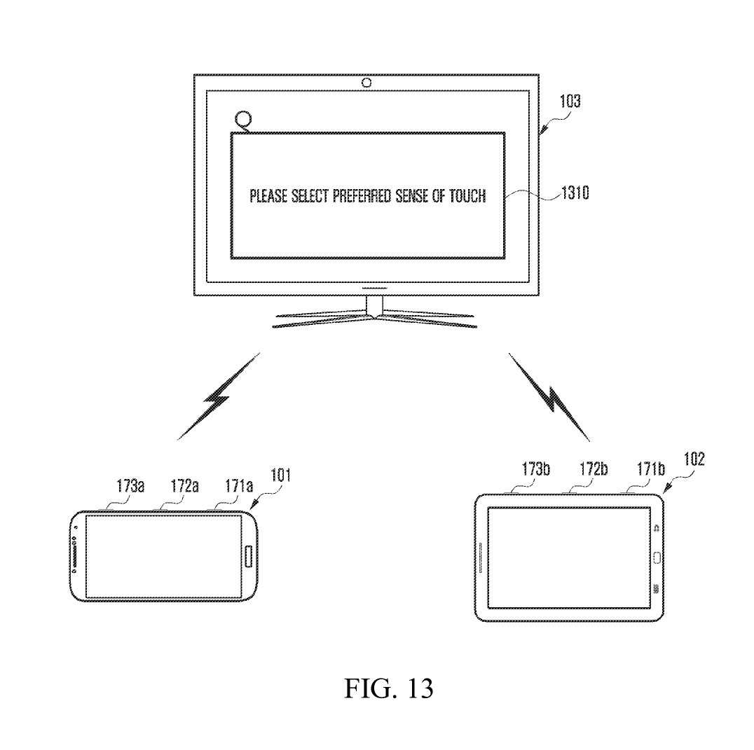

Referring to FIG. 13, the system 1000, according to the embodiment of the present disclosure, may provide a matching game service. For example, the third electronic device 103 may output a popup window 1310, “Please select a preferred sense of touch!” The third electronic device 103 transmits tactile information to the first electronic device 101 and the second electronic device 102. For example, if it is assumed that each of the first electronic device 101 and the second electronic device 102 includes three tactile sensors, the third electronic device 103 may transmit tactile information to the first electronic device 101 and the second electronic device 102 such that the first tactile sensors 171a and 171b, the second tactile sensors 172a and 172b, and the third tactile sensors 173a and 173b provide different degrees of feelings of hardness.

The first electronic device 101 and the second electronic device 102 having received the tactile information may provide the received tactile information through the plurality of tactile sensors. For example, the first electronic device 101 and the second electronic device 102 may provide the feeling of hardness with a first strength through the first tactile sensors 171a and 171b, the feeling of hardness with a second strength through the second tactile sensors 172a and 172b, and the feeling of hardness with a third strength through the third tactile sensors 173a and 173b.

Users of the first electronic device 101 and the second electronic device 102 may touch the first tactile sensors 171a and 171b, the second tactile sensors 172a and 172b, and the third tactile sensor 173a and 173b and then select the tactile sensors that provide a sense of touch with a preferred strength.

The first electronic device 101 and the second electronic device 102 may transmit information on the tactile sensors selected by the users to the third electronic device 103. The third electronic device 103 may compare the tactile sensor information received from the first electronic device 101 and the second electronic device 102 to determine whether the tactile sensor information agrees with each other, and may feed the determination result back to the first electronic device 101 and the second electronic device 102. For example, in cases where the users of the first electronic device 101 and the second electronic device 102 select an identical tactile sensor, the third electronic device 103 may provide, to the first electronic device 101 and the second electronic device 102, feedback for notifying that their preferred senses of touch are the same as each other. Meanwhile, in cases where the users of the first electronic device 101 and the second electronic device 102 select different tactile sensors, the third electronic device 103 may provide, to the first electronic device 101 and the second electronic device 102, feedback for informing that their preferred senses of touch are different from each other. Further, the third electronic device 103 may transmit, to the first electronic device 101, the selection result of the second electronic device 102 together with the feedback for informing that the preferred senses of touch differ from each other, and may transmit, to the second electronic device 102, the selection result of the first electronic device 101 together with the feedback for informing that the preferred senses of touch differ from each other.

Further, in cases where the preferred senses of touch agree with each other, the third electronic device 103 may output text (e.g., PASS) to inform of a success and then may output the next problem. Meanwhile, in cases where the preferred senses of touch do not agree with each other, the third electronic device 103 may output text (e.g., Fail) to inform of a failure along with text for requesting reselection.

According to various embodiments, at least some of the devices (e.g., modules or functions thereof) or the method (e.g., operations) according to the present disclosure may be implemented by a command stored in a computer-readable storage medium in a programming module form. When the command is executed by one or more processors (e.g., the controller 110), the one or more processors may execute a function corresponding to the command At least some of the programming modules may be implemented (e.g., executed) by, for example, the processor. At least some of the programming modules may include, for example, a module, a program, a routine, a set of instructions or a process for performing one or more functions.

The computer readable recording medium may include magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions may include high class language codes, which can be executed in a computer by using an interpreter, as well as machine codes made by a compiler Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

The various embodiments of the present disclosure disclosed in the present specification and the drawings have been presented to help comprehension of the present disclosure, and are not intended to limit the scope of various embodiments of the present disclosure. Therefore, it should be construed that, in addition to the embodiments disclosed herein, all modifications and changes or modified and changed forms derived from the technical idea of various embodiments of the present disclosure fall within the scope of the present disclosure.

What is claimed is:

1. An electronic device comprising:
at least one tactile sensor that is located on a side of the electronic device and provides a sense of touch;
a display unit that displays content; and
a controller that controls the at least one tactile sensor to provide a sense of touch relevant to the content.

2. The electronic device of claim 1, wherein the side of the electronic device includes at least one of a top, a bottom, a left side, a right side, a front, and a rear, and wherein the at least one tactile sensor is located on at least one of the top, the bottom, the left side, the right side, the front, and the rear of the electronic device.

3. The electronic device of claim 1, wherein the at least one tactile sensor receives a touch input and a touch movement input.

4. The electronic device of claim 1, further comprising:
a storage unit that stores a tactile database in which at least one of an object and a function is mapped with tactile information.

5. The electronic device of claim 4, wherein the storage unit stores unlocking tactile information to unlock the electronic device, and the controller unlocks the electronic device when information input through the at least one tactile sensor corresponds to the unlocking tactile information while the electronic device is locked.

6. The electronic device of claim 1, further comprising:
a communication unit that establishes at least one of a wired communication connection and a wireless communication connection with a second electronic device,
wherein the controller receives tactile information from the second electronic device through the communication unit and controls the at least one tactile sensor to provide a sense of touch corresponding to the tactile information received by the controller.

7. The electronic device of claim 6, wherein the controller transmits an input received through the at least one tactile sensor to the second electronic device, and receives feedback on the input from the second electronic device.

8. A method of operating an electronic device including at least one tactile sensor, comprising:
displaying content containing tactile information; and
providing a sense of touch relating to the content through the at least one tactile sensor.

9. The method of claim 8, further comprising:
receiving an input through the tactile sensor; and
processing the input.

10. The method of claim 9, wherein processing the input comprises:
unlocking the electronic device when the input received through the at least one tactile sensor corresponds to preset unlocking tactile information while the electronic device is locked.

11. The method of claim 9, wherein processing the input comprises:
turning volume up or down in response to the input received through the tactile sensor.

12. The method of claim 9, wherein processing the input comprises:
performing a page turning operation or a screen transition operation in response to the input received through the tactile sensor.

13. The method of claim 9, wherein processing the input comprises:
controlling a car game in response to the input received through the tactile sensor.

14. A method of operating an electronic device including at least one tactile sensor, comprising:
establishing wired or wireless communication connection with a second electronic device;
receiving tactile information from the second electronic device; and
providing the tactile information received through the at least one tactile sensor.

15. The method of claim 14, further comprising:
receiving an input through the at least one tactile sensor;
transmitting the received input to the second electronic device; and
receiving feedback on the input from the second electronic device and displaying the feedback received.

16. A system comprising:
a first electronic device that comprises at least one tactile sensor on a side thereof and provides a sense of touch through the at least one tactile sensor; and
a second electronic device that displays content containing tactile information and transmits tactile information corresponding to the content to the first electronic device.

17. The system of claim 16, wherein the first electronic device receives an input through the at least one tactile sensor and transmits, to the second electronic device, information on the tactile sensor through which the input is received.

18. The system of claim 17, wherein the second electronic device processes a function according to the information on the tactile sensor transmitted from the first electronic device and transmits a result of the function processed according to the information on the tactile sensor to the first electronic device.

19. The system of claim 18, wherein the first electronic device performs a function according to the result of the function processed transmitted from the second electronic device.
